(19) United States
(12) Patent Application Publication
(10) Pub. No.: US 2012/0325661 A1
(43) Pub. Date: Dec. 27, 2012

(54) GAS SENSOR

(75) Inventors: Makoto KUME, Inuyama-shi (JP); Nobuhiro INOUE, Tajimi-shi (JP); Takashi NAKASHIMA, Inuyama-shi (JP)

(73) Assignee: NGK SPARK PLUG CO., LTD., Nagoya-shi (JP)

(21) Appl. No.: 13/491,078

(22) Filed: Jun. 7, 2012

(30) Foreign Application Priority Data
Jun. 10, 2011 (JP) 2011-129836
Apr. 25, 2012 (JP) 2012-099980

(51) Int. Cl. G01N 27/26; G01M 15/10

(52) U.S. Cl. 204/424

(57) ABSTRACT

A gas sensor includes a plate-like gas sensor element, a tubular metallic shell which holds the gas sensor element, and a seal member disposed between the inner surface of the metallic shell and outer surface of the gas sensor element. The gas sensor further includes a metal packing having a through-hole of substantially rectangular cross section through which the gas sensor element extends, and pressing forward the seal member with a flat surface thereof in direct contact with the rearward oriented surface of the seal member. The flat surface of the metal packing has an outside diameter equal to or greater than that of the rearward oriented surface of the seal member. A clearance between an inner edge of the flat surface of the metal packing and the surface of the gas sensor element is one-half or less the thickness of the gas sensor element.

### TECHNICAL FIELD

The present invention relates to a gas sensor having a gas sensor element for detecting the concentration of a gas to be detected.

### Background Art

A known gas sensor for detecting the concentration of oxygen, NOₓ, etc., in exhaust gas from, for example, an automobile includes a gas sensor element which has at least one cell composed of an oxygen ion conductive solid electrolyte body and a pair of electrodes provided on the surface of the solid electrolyte body.

In the gas sensor, the gas sensor element is inserted through and held in a tubular metallic shell, and a seal member (a powder filler layer of talc) is provided in an intervening manner in a gap between the gas sensor element and the metallic shell. An annular ceramic sleeve and an annular metal packing are disposed rearward of the seal member and press the seal member forward as a result of a rear end of the metallic shell being crimped. The pressing action causes the seal member to fill the gap, thereby maintaining gastightness in the gap (refer to Patent Documents 1 and 2).

### PRIOR ART DOCUMENTS

### Patent Documents

[Patent Document 1] Japanese Patent Application Laid-Open (kokai) No. 2009-287935 (FIG. 1)
[Patent Document 2] Japanese Patent Application Laid-Open (kokai) No. 2007-205985

### SUMMARY OF THE INVENTION

### Problems to be Solved by the Invention

The ceramic sleeve formed from alumina or the like is high in cost. Also, since the ceramic sleeve must be relatively thick for ensuring strength, the gas sensor element held in the metallic shell becomes long accordingly in the axial direction. As a result, in the case where the gas sensor element is assembled into the metallic shell eccentrically relative to the metallic shell, the gas sensor element inserted through the ceramic sleeve interferes with the ceramic sleeve. In this condition, when pressing force stemming from crimping is applied to the seal member, the gas sensor element moves in such a manner as to reduce the eccentricity. Therefore, bending stress is generated in the gas sensor element in association with bending of the gas sensor element at a fulcrum point of the seal member, potentially resulting in occurrence of cracking in or breakage of the gas sensor element.

In view of the foregoing, an object of the present invention is to provide a gas sensor in which the occurrence of cracking or breakage is reduced for a gas sensor element which is inserted through and held, via a seal member, in a metallic shell and which enables reduction in cost.

### Means for Solving the Problems

To achieve the above object, a gas sensor of the present invention comprises a plate-like gas sensor element extending in an axial direction and having at least one cell which includes a solid electrolyte body and a pair of electrodes provided on a surface of the solid electrolyte body; a tubular metallic shell having a through-hole through which the gas sensor element extends, and adapted to hold the gas sensor element in such a manner that a detection portion formed at a forward end portion of the gas sensor element projects therefrom; and a seal member disposed between an inner surface of the metallic shell and an outer surface of the gas sensor element and adapted to maintain gastightness in a gap between the gas sensor element and the metallic shell. The gas sensor further comprises a metal packing having a through-hole which has a substantially rectangular cross section and through which the gas sensor element extends, and pressing forward the seal member with a flat surface thereof in direct contact with a rearward oriented surface of the seal member. The flat surface of the metal packing has an outside diameter equal to or greater than that of the rearward oriented surface of the seal member, and a clearance between an inner edge of the flat surface of the metal packing and a surface of the gas sensor element is one-half or less a thickness of the gas sensor element.

According to this gas sensor, the flat surface of the metal packing is in direct contact with the rearward oriented surface of the seal member and presses the seal member forward. This allows elimination of the conventionally employed ceramic sleeve, thereby reducing cost. Also, even when the metal packing is reduced in thickness as compared with the ceramic sleeve, the metal packing can provide required strength; thus, the gas sensor element extending through and held in the metallic shell can be reduced in length along the axial direction. Accordingly, an interference length along which the gas sensor element extending through the metal packing interferes with the metal packing can be reduced. Therefore, the occurrence of cracking in and breakage of the gas sensor element can be reduced.

Furthermore, the metal packing has a through-hole which has a substantially rectangular cross section and through which the gas sensor element extends; the flat surface of the metal packing has an outside diameter equal to or greater than that of the rearward oriented surface of the seal member; and the clearance between an inner edge of the flat surface of the metal packing and the surface of the gas sensor element is one-half or less the thickness of the gas sensor element. Thus, the flat surface of the metal packing can reliably press the seal member, so that the pressed seal member reliably fills a relevant space, thereby reliably maintaining gastightness in a gap between the gas sensor element and the metallic shell. When the outside diameter of the flat surface of the metal packing is less than that of the rearward oriented surface of the seal member or when the clearance between an inner edge of the flat surface of the metal packing and the surface of the gas sensor element is in excess of one-half the thickness of the gas sensor element, the seal member fails to fill the relevant space, resulting in a failure to maintain gastightness in the gap between the gas sensor element and the metallic shell. Notably, “the clearance between an inner edge of the flat surface of the metal packing and the surface of the gas sensor element” refers to each of four clearances provided between four surfaces of the plate-like gas sensor element and corresponding four inner edges of the flat surface of the metal packing (four inner edges which define a rectangular shape of the through-hole of the metal packing). As shown in FIG. 5, the clearance can be checked on a section which is taken radially and contains the flat surface of the metal packing.

Furthermore, in the present invention, preferably, thermal expansion coefficient of the metal packing is higher than that of the metallic shell. In this case, in exposure to heating and cooling cycles, the metal packing thermally expands in the axial direction more than does the metallic shell. Therefore, in the course of thermal expansion, the pressing (compression) force applied to the seal member does not weaken, thereby preventing breakage of gastightness in the gap between the gas sensor element and the metallic shell.

Furthermore, in the present invention, preferably, side surfaces of the gas sensor element disposed in the through-hole of the metal packing are formed from an insulation material. In order to reliably press the seal member by means of the flat surface of the metal packing, preferably, the clearance between an inner edge of the flat surface of the metal packing and the surface of the gas sensor element is equal to or less than that between an inner edge of the rearward oriented surface of the seal member and the surface of the gas sensor element. At this time, the clearance between the metal packing and the gas sensor element may become relatively narrow, and in some cases (for example, in the case where the seal member comes into contact with the sensor element), the metal packing and the gas sensor element may come into contact with each other. In this case, when the side surfaces of the gas sensor element are formed from an insulation material, the solid electrolyte body of the gas sensor element does not come into contact with the metal packing, thereby preventing electrical communication between the gas sensor element and the metallic shell via the metal packing.

Furthermore, in the present invention, preferably, a gap between the metallic shell and the metal packing is smaller than that between the gas sensor element and the metal packing. In this manner, by means of the metal packing being disposed in the gap between the gas sensor element and the metallic shell in such a manner as to be closer to the metallic shell, radial movement of the metal packing can be limited, thereby preventing contact between the gas sensor element and the metal packing. As a result, electrical communication between the gas sensor element and the metallic shell via the metal packing can be prevented.

Furthermore, in the present invention, preferably, the metallic shell has a crimp portion located rearward of the metal packing, projecting radially inward while having a gap between the same and the gas sensor element, and pressing forward the metal packing; the metal packing has a maximum thickness T at a position where the metal packing and the crimp portion overlap each other in the axial direction; and the maximum thickness T of the metal packing is greater than a maximum thickness t of the crimp portion.

In a gas sensor in which the metallic shell has a crimp portion provided at the rear end thereof and adapted to press forward the metal packing, in order to avoid contact between the crimp portion and the sensor element, preferably, a gap is provided between the crimp portion and the sensor element. However, as a result of provision of the gap, the crimp portion fails to cover the entire metal packing in the axial direction; therefore, difficulty may be encountered in applying a predetermined pressing force to a portion of the flat surface of the metal packing in the vicinity of the inner edges of the flat surface. However, according to the gas sensor of the present invention, the metal packing has the maximum thickness T at a position where the metal packing and the crimp portion overlap each other in the axial direction, and the maximum thickness T of the metal packing is greater than the maximum thickness t of the crimp portion. Thus, even though a gap exists between the crimp portion and the sensor element, a predetermined pressing force can be applied to a portion of the flat surface of the metal packing in the vicinity of the inner edges of the flat surface, so that the entire flat surface of the metal packing can reliably press the seal member.

Notably, when the flat surface of the metal packing assumes such a form as to be shifted forward while extending radially outward, the flat surface of the metal packing can press the seal member with greater force.

Furthermore, in the present invention, preferably, as viewed on a section which is taken radially and contains the flat surface of the metal packing, the gas sensor element has a substantially rectangular shape such that a length in a width direction is longer than a length in a thickness direction, and the clearance in the thickness direction between the gas sensor element and the metal packing is smaller than the clearance in the width direction between the gas sensor element and the metal packing.

In the gas sensor element whose cross section has a substantially rectangular shape such that the length in the width direction is longer than the length in the thickness direction, by means of the clearance in the thickness direction between the gas sensor element and the metal packing being smaller than the clearance in the width direction between the gas sensor element and the metal packing, the flat surface of the metal packing can press the seal member more reliably.

Furthermore, in the present invention, the metallic shell may have a hexagonal portion, a threaded portion disposed forward of the hexagonal portion and having a diameter smaller than that of the hexagonal portion, and a ledge projecting radially inward into the through-hole thereof and being in direct or indirect contact with a forward end of the seal member, and may be such that a rearward oriented surface of the ledge is located rearward of the threaded portion.

According to this gas sensor, since the ledge portion subjected to the most intensive pressing force from the powder filler layer is located rearward of the thin-walled threaded portion, the pressing force is not applied to the threaded portion, thereby preventing breakage of gastightness in the gap between the gas sensor element and the metallic shell, which could otherwise result from elongation of the threaded portion in the axial direction.

### Effect of the Invention

The present invention reduces the occurrence of cracking in and breakage of the gas sensor element which extends through and is held in the metallic shell, and can reduce the cost of manufacturing the gas sensor.

### BRIEF DESCRIPTION OF THE DRAWINGS

FIG. 1 Sectional view, taken along the axial direction, of a gas sensor according to an embodiment of the present invention.

FIG. 2 Perspective view showing the arrangement of an elastic member, metal terminals, and an insulation member within an outer tube, and a metallic shell.

FIG. 3 A series of process drawings showing an example method of manufacturing the gas sensor according to the embodiment of the present invention.

FIG. 4 Enlarged sectional view showing essential portions of the gas sensor according to the embodiment of the present invention.

FIG. 5 Sectional view, taken along a flat surface of a metal packing (taken along line A-A of FIG. 4), of the gas sensor according to the embodiment of the present invention.

FIG. 6 Enlarged sectional view showing essential portions of a gas sensor according to a modified embodiment of the present invention.

### MODES FOR CARRYING OUT THE INVENTION

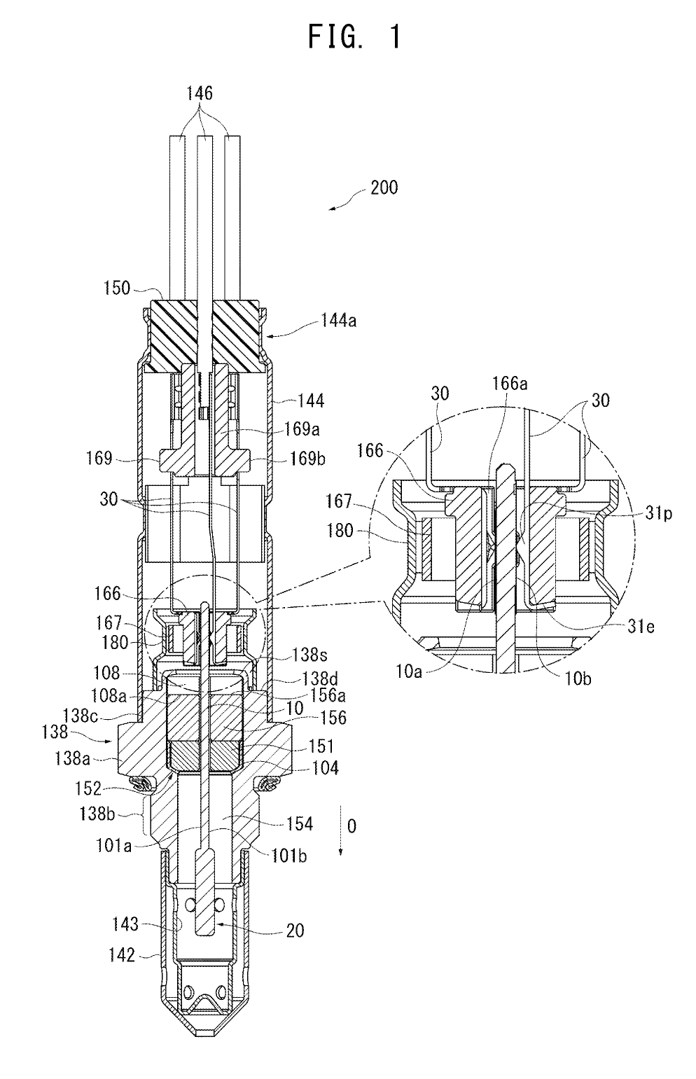

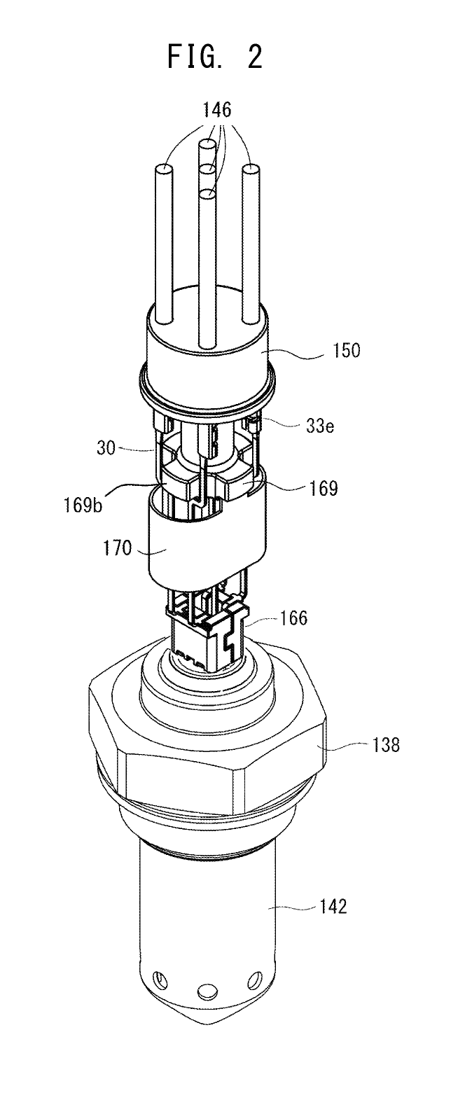

FIG. 1 is a sectional view, taken along the axial direction O (along the longitudinal direction; i.e., the vertical direction on the paper on which FIG. 1 appears), of a gas sensor (oxygen sensor) 200 according to an embodiment of the present invention. FIG. 2 is a perspective view showing the arrangement of an elastic member 150, metal terminals 30, and an insulation member 166 within an outer tube 144, and a metallic shell 138. For plainly showing the arrangement of the metal terminals 30, in FIG. 2, the outer tube 144, an inner tube 180, and a nipping member 167 are eliminated. The oxygen sensor 200 includes the metallic shell 138, which has a threaded portion 138b formed on its outer surface and adapted to be fixed to an exhaust pipe; an oxygen sensor element (gas sensor element) 10 having a plate-like shape and extending in the axial direction O; the insulation member 166, which has a contact insertion hole 166a extending therethrough in the axial direction O and is disposed such that the inner wall surface of the contact insertion hole 166a surrounds a rear end portion of the oxygen sensor element 10; the inner tube 180 of metal, which surrounds the insulation member 166 and is connected to the metallic shell 138; the five metal terminals 30 (FIG. 1 shows three of them), whose forward end portions are held to the insulation member 166 while being spaced apart from one another; five lead wires 146 (FIG. 1 shows three of them), which are electrically connected to rear end portions of the respective metal terminals 30 and extend outward from the oxygen sensor 200; a separator-holding member 170, which is disposed rearward of the insulation member 166; a separator 169; and the elastic member (rubber cap) 150 of rubber. Also, an outer tube 144 formed of metal is connected to the rear end of the metallic shell 138.

The oxygen sensor element 10 is a full-range air/fuel ratio sensor element and has a publicly known structure. Briefly, the oxygen sensor element 10 has a detection portion provided at a forward end portion thereof and including a measuring chamber into which gas to be measure (exhaust gas) is introduced, a first pumping cell, and an oxygen concentration detection cell. Each of the cells is composed of a solid electrolyte body and a pair of electrodes. Also, the oxygen sensor element 10 has a heater for activating the cells. The heater is configured such that a heat-generating resistor is sandwiched between insulation layers (alumina layers).

The oxygen sensor element 10 has two opposite surfaces 101a and 101b, and the insulation layer of the heater is exposed at the surface 101a; the solid electrolyte body of the oxygen concentration detection cell faces the other surface 101b; and the outer surface of the solid electrolyte body is covered with an insulation layer. Furthermore, two other surfaces of the oxygen sensor element 10 connected to the two surfaces 101a and 101b, respectively, are also covered with respective insulation layers. Thus, the four surfaces of the oxygen sensor element 10 are of an insulation material. Therefore, even though a metal packing 108, which will be described later, is used in holding the oxygen sensor element 10 in the metallic shell 138, the solid electrolyte body of the oxygen sensor element 10 does not come into contact with the metal packing 108, thereby preventing electrical communication between the oxygen sensor element 10 and the metallic shell 138 via the metal packing 108.

Electrode terminals 10a and 10b are provided on the two surfaces 101a and 101b of a rear end portion of the oxygen sensor element 10 and are electrically connected to the two cells and the heater for leading out outputs from the two cells and supplying power to the heater.

FIG. 1 shows a section perpendicular to the two surfaces 101a and 101b of the oxygen sensor element 10. In FIG. 1, two electrode terminals 10a are formed on one surface 101a (left-hand surface in FIG. 1) of the oxygen sensor element 10, and three electrode terminals 10b are formed on the other surface 101b (right-hand surface in FIG. 1). Also, the outer surface of a forward end portion of the oxygen sensor element 10 is covered with a porous protection layer 20.

The metallic shell 138 has a substantially tubular shape and has a through-hole 154 extending therethrough in the axial direction O and a hexagonal portion 138a projecting radially outward and allowing a tool to be engaged for rotating the threaded portion 138b. Also, the metallic shell 138 has a ledge 152 projecting radially inward into the through-hole 154 and assuming the form of a radially inward oriented taper surface inclined from a plane perpendicular to the axial direction O. The metallic shell 138 holds the oxygen sensor element 10 in the through-hole 154 in such a state that a forward end portion, where the detection portion is provided, of the oxygen sensor element 10 is disposed externally of the forward end of the through-hole 154 and that a rear end portion, where the electrode terminals 10a and 10b are provided, of the oxygen sensor element 10 is disposed externally of the rear end of the through-hole 154.

The rearward oriented surface of the ledge 152 is located rearward of the rear end of the threaded portion 138b.

In the through-hole 154 of the metallic shell 138, an annular ceramic holder 151, a powder filler layer 156 (talc ring), and the above-mentioned metal packing 108 are stacked in this order from the forward side to the rear side in such a manner as to radially surround the oxygen sensor element 10. Also, a metal holder 104 for holding the ceramic holder 151 is disposed between the ceramic holder 151 and the ledge 152 of the metallic shell 138. The metallic shell 138 has a crimp portion 138s, which presses forward the metal packing 108, at a rear end portion thereof. The crimp portion 138s, when crimped, compresses the powder filler layer 156 via the metal packing 108, whereby gastightness is maintained in the gap between the oxygen sensor element 10 and the metallic shell 138. A plurality of the powder filler layers 156 may be disposed in the axial direction O. The powder filler layer 156 corresponds to the “seal member” appearing in claims.

The metal packing 108 assumes the form of a disk and has a substantially rectangular through-hole at the center for allowing the oxygen sensor element 10 to extend therethrough. A forward oriented surface 108a of the metal packing 108 is flat so as to come into close and direct contact with a rearward oriented surface 156a of the powder filler layer 156. The metal packing 108 can be manufactured by use of, for example, any one of various stainless steels.

The forward oriented surface 108a corresponds to the “flat surface” appearing in claims.

The forward oriented surface 108a of the metal packing 108 is in direct contact with the rearward oriented surface 156a of the powder filler layer 156 and presses forward the powder filler layer 156. Thus, a ceramic sleeve used conventionally for pressing (compressing) the powder filler layer 156 from the rear side can be eliminated, whereby cost can be reduced. Also, even when the thickness of the metal packing 108 is reduced, the metal packing 108 can maintain a required strength; thus, the oxygen sensor element 10 extending through and held in the metallic shell 138 can be reduced in length along the axial direction O. Accordingly, an interference length along which the oxygen sensor element 10 extending through the metal packing 108 interferes with the metal packing 108 can be reduced. Therefore, the occurrence of cracking in and breakage of the oxygen sensor element 10 can be reduced.

The ledge 152 indirectly holds a forward end portion of the powder filler layer 156 via the ceramic holder 151 and the metal holder 104. However, the ceramic holder 151 may be eliminated such that the powder filler layer 156 is disposed within the metal holder 104.

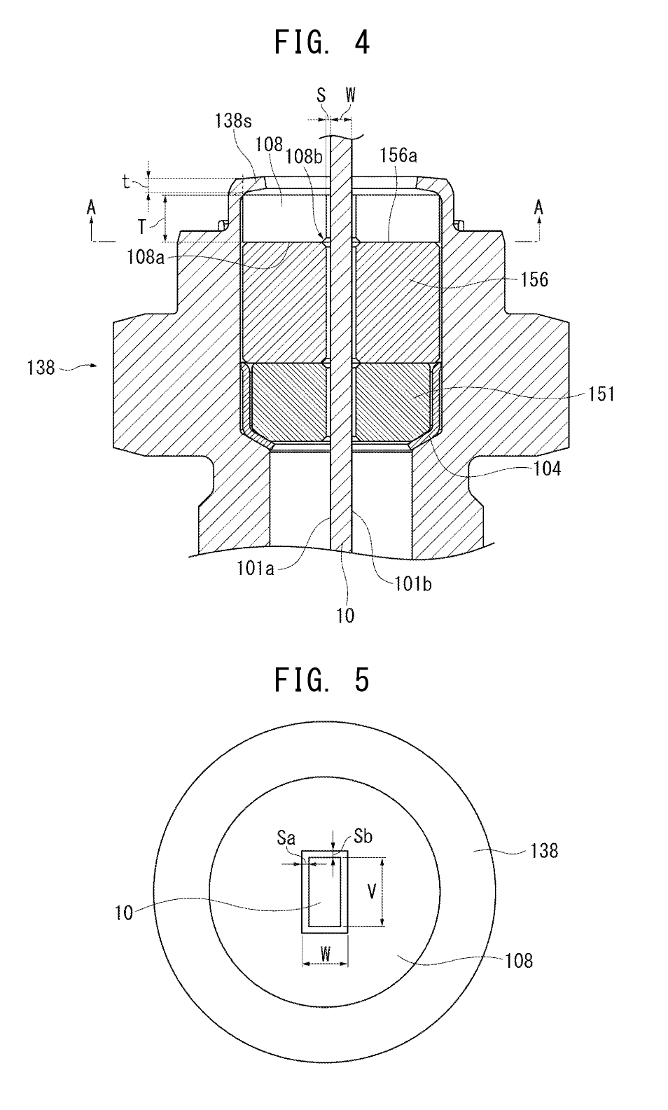

Furthermore, as shown in FIG. 4, the forward oriented surface 108a of the metal packing 108 has an outside diameter equal to or greater than that of the rearward oriented surface 156a of the powder filler layer 156, and a clearance S between the inner edge 108b of the forward oriented surface 108a of the metal packing 108 and the surface 101a of the oxygen sensor element 10 is one-half or less a thickness W of the oxygen sensor element 10. The thickness W of the oxygen sensor element 10 indicates the length between the two surfaces 101a and 101b of the oxygen sensor element 10 (the horizontal length in FIG. 4). In the present embodiment, the forward oriented surface 108a of the metal packing 108 and the rearward oriented surface 156a of the powder filler layer 156 have the same outside diameter. Also, in the present embodiment, the oxygen sensor element 10 has a thickness W of 1 mm to 1.5 mm, and the clearance S is 0.05 mm to 0.1 mm. Thus, the forward oriented surface 108a of the metal packing 108 can reliably press the powder filler layer 156, so that the pressed powder filler layer 156 reliably fills a relevant space; therefore, gastightness is reliably maintained in the gap between the oxygen sensor element 10 and the metallic shell 138. The establishment of the following relational features is described above with respect to a region on the left side of FIG. 4: the forward oriented surface 108a of the metal packing 108 has an outside diameter equal to or greater than that of the rearward oriented surface 156a of the powder filler layer 156, and the clearance S between the inner edge 108b of the forward oriented surface 108a of the metal packing 108 and the surface 101a of the oxygen sensor element 10 is one-half or less the thickness W of the oxygen sensor element 10. Needless to say, the above relational features are also established with respect to a region on the right side of FIG. 4 (i.e., a region on a side toward the surface 101b of the oxygen sensor element 10). Furthermore, the above relational features are also established with respect to regions on the sides toward two other surfaces connected to the surfaces 101a and 101b of the oxygen sensor element 10.

In exposure to heating and cooling cycles, the metallic shell 138 thermally expands in the axial direction O; as a result, the pressing (compression) force applied to the seal member (powder filler layer) 156 may weaken, potentially resulting in breakage of gastightness in the gap between the gas sensor element 10 and the metallic shell 138. In view of this, by means of the metal packing 108 having thermal expansion coefficient higher than that of the metallic shell 138, the metal packing 108 thermally expands in the axial direction O more than does the metallic shell 138. Therefore, in the course of thermal expansion, the pressing (compression) force applied to the seal member (powder filler layer) 156 does not weaken, thereby preventing breakage of gastightness in the gap between the oxygen sensor element 10 and the metallic shell 138.

In the case where the metallic shell 138 is formed from, for example, SUS430, by means of the metal packing 108 being formed from SUS304, the thermal expansion coefficient of the metal packing 108 becomes higher than that of the metallic shell 138.

Since the thickness of the metal packing 108 can be reduced, the ledge 152 for holding a forward end portion of the powder filler layer 156 can be disposed rearward of a conventional position. Particularly, when the rearward oriented surface of the ledge 152 is located rearward of the threaded portion 138b, the ledge 152 subjected to the most intensive pressing force from the powder filler layer 156 is located rearward of the thin-walled threaded portion 138b. Thus, the pressing force is not applied to the threaded portion 138b, thereby preventing breakage of gastightness in the gap between the oxygen sensor element 10 and the metallic shell 138, which could otherwise result from elongation of the threaded portion 138b in the axial direction O.

Furthermore, the gap between the metallic shell 138 and the metal packing 108 is smaller than that between the oxygen sensor element 10 and the metal packing 108. In this manner, by means of the metal packing 108 being disposed in the gap between the oxygen sensor element 10 and the metallic shell 138 in such a manner as to be closer to the metallic shell 138, radial movement of the metal packing 108 can be limited, thereby preventing contact between the oxygen sensor element 10 and the metal packing 108. As a result, electrical communication between the oxygen sensor element 10 and the metallic shell 138 via the metal packing 108 can be prevented.

Furthermore, as shown in FIG. 4, the metal packing 108 has the maximum thickness T at a position where the metal packing 108 and the crimp portion 138s overlap each other in the axial direction O, and the maximum thickness T of the metal packing 108 is greater than the maximum thickness t of the crimp portion 138s. Thus, even though a gap exists between the crimp portion 138s and the oxygen sensor element 10, a predetermined pressing force can be applied to a portion of the flat surface 108a of the metal packing 108 in the vicinity of the inner edges 108b of the flat surface 108a, so that the entire flat surface 108a of the metal packing 108 can reliably press the powder filler layer 156.

Furthermore, as shown in FIG. 5, a clearance Sa in the thickness direction between the oxygen sensor element 10 and the metal packing 108 is smaller than a clearance Sb in the width direction between the oxygen sensor element 10 and the metal packing 108. In the oxygen sensor element 10 whose cross section has a substantially rectangular shape such that a length V in the width direction is longer than a length W in the thickness direction, by means of the clearance Sa in the thickness direction between the oxygen sensor element 10 and the metal packing 108 being smaller than the clearance Sb in the width direction between the oxygen sensor element 10 and the metal packing 108, the flat surface 108a of the metal packing 108 can press the powder filler layer 156 more reliably.

Referring back to FIG. 1, a dual-structure protector consisting of an outer protector 142 and an inner protector 143, each having a plurality of holes and being made of metal (e.g., stainless steel), is joined by welding or the like to the outer circumference of a forward end portion (a lower end portion in FIG. 1) of the metallic shell 138 while covering a forward end portion of the oxygen sensor element 10.

Meanwhile, while a forward end portion of the outer tube 144 is externally fitted to an outer circumferential surface 138c of a rear end portion of the metallic shell 138, the outer tube 144 is welded to the metallic shell 138. The outer tube 144 has a tubular shape, and the elastic member 150 is fitted into a rear end portion of the outer tube 144, thereby sealing the outer tube 144.

The separator-holding member 170 and the separator 169 are disposed forward of the elastic member 150 within the outer tube 144 in this order from the forward side to the rear side while being in contact with each other in the axial direction O. The elastic member 150 and the separator-holding member 170 are crimped radially inward via the outer tube 144, thereby holding the separator 169 within the outer tube 144 by means of elastic forces of the elastic member 150 and the separator-holding member 170.

The elastic member 150 assumes the form of a circular column and has through-holes for allowing lead wires to extend therethrough in the axial direction O. The separator-holding member 170 is a tubular member made of metal.

The separator 169 is formed from, for example, ceramic and has a body portion 169a and a plurality of projections 169b projecting radially outward from the body portion 169a. The metal terminals 30 are disposed one by one between two adjacent protrusions 169b, thereby preventing short circuit between the metal terminals 30.

Furthermore, the insulation member 166 is disposed forward of the separator-holding member 170 within the outer tube 144. The insulation member 166 assumes a substantially plate-like shape and is divided into two pieces along the axial direction O; after the metal terminals 30 are assembled to the two divided pieces, the two pieces are assembled together; and the nipping member 167 having the nature of a spring is externally fitted to the perimeters of the pieces, thereby joining (nipping) the pieces together. At this time, L-shaped latch ends 31e at the forward ends of the metal terminals 30 are latched to the forward oriented surface of the insulation member 166, thereby fixing the metal terminals 30. The metal terminals 30 are held within the insulation member 166 in such a manner as to face the contact insertion hole 166a.

Meanwhile, the metal terminals 30 have protrusions 31p formed at respective forward end portions thereof and located within the contact insertion hole 166a. The protrusions 31p come into electrical contact with the electrode terminals 10a and 10b, respectively, of the oxygen sensor element 10. In this manner, a terminal connection structure is formed. The metal terminals 30 are connected to the respective lead wires 146 at crimp terminal portions 33e formed at their rear ends.

Furthermore, the inner tube 180 is disposed radially outward of the insulation member 166 and the nipping member 167 within the outer tube 144. The inner tube 180 is crimped radially inward; as a result, the nipping member 167 is pressed and deformed so as to externally nip the two pieces of the insulation member 166, thereby ensuring electrical connection between the electrode terminals 10a and 10b and the metal terminals 30.

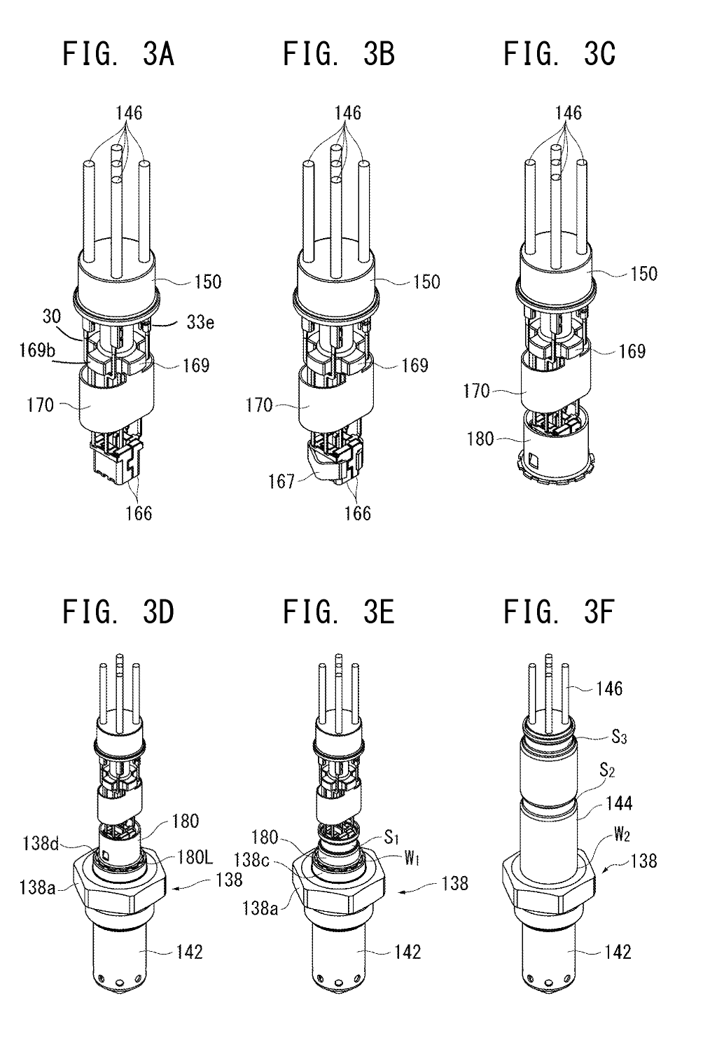

FIG. 3 is a series of process drawings showing an example method of manufacturing the sensor 200 according to the embodiment of the present invention. For easy visibility of component members, in FIG. 3, the lead wires 146 face upward. However, in the course of actual manufacture, the lead wires 146 face downward.

First, the metal terminals 30 (not shown) are assembled to the two divided pieces of the insulation member 166, and the separator-holding member 170 and the separator 169 are assembled in this order to a rear side of the insulation member 166. Furthermore, the lead wires 146 connected to the rear ends of the metal terminals 30 are inserted through the respective through-holes of the elastic member 150 so as to be led out from the rear end of the elastic member 150 (FIG. 3(a)).

Next, the nipping member 167 having the nature of a spring is externally fitted to the perimeters of the two pieces of the insulation member 166, thereby joining (nipping) the two pieces of the insulation member 166 together (FIG. 3(b)).

Next, the inner tube 180 is put in a surrounding manner on the two pieces of the insulation member 166 and the nipping member 167 (FIG. 3(c)). In order to increase the area of contact with the metallic shell 138, in the present embodiment, an end of the inner tube 180 is expanded radially outward in a petal fashion, thereby forming a flange 180L. However, the end of the inner tube 180 may be a mere cut end.

Then, the flange 180L is brought into contact with a rearward oriented surface 138d of the metallic shell 138 (FIG. 3(d)). The metallic shell 138 is prepared beforehand in the following manner: the dual-structure protector consisting of the outer protector 142 and the inner protector 143 is welded to the metallic shell 138; furthermore, the oxygen sensor element 10, the metal holder 104, the ceramic holder 151, the power filler layer 156, and the metal packing 10 are disposed therein, followed by crimping of a rear end portion of the metallic shell 138 to thereby form the crimp portion 138s. When the flange 180L is brought into contact with the rearward oriented surface 138d of the metallic shell 138, a rear end portion of the oxygen sensor element 10 is inserted into the contact insertion hole 166a of the insulation member 166, whereby the electrode terminals 10a and 10b come into contact with the respective metal terminals 30.

Next, the inner tube 180 is crimped radially inward at a crimp portion S1. This causes the nipping member 167 to be deformed in such a manner as to nip the two pieces of the insulation member 166 from radially outside. Furthermore, when the inner tube 180 is crimped, the inner tube 180 positionally shifts in such a manner as to absorb center misalignment, if any, of the oxygen sensor element 10 without imposition of excess force on the electrode terminals 10a and 10b of the sensor element 10.

The thus-positionally-shifted inner tube 180 is welded to the rearward oriented surface 138d of the metallic shell 138 (welding position W1) (FIG. 3(e)).

Next, the outer tube 144 is disposed radially outward of the inner tube 180. The forward end of the outer tube 144 is externally fitted to the outer circumferential surface 138c (see FIG. 3(e)) of a rear end portion of the metallic shell 138. Then, the outer tube 144 is crimped radially inward at crimp portions S2 and S3 so as to hold the separator-holding member 170 and the elastic member 150 within the outer tube 144. Subsequently, a forward end portion of the outer tube 144 and the outer circumferential surface 138c of the metallic shell 138 are welded (welding position W2), thereby joining the outer tube 144 to the metallic shell 138 (FIG. 3(f)).

The oxygen sensor 200 is thus completed.

### EXAMPLES

In order to form a sample assembly of Example 1, there were prepared the metallic shell 138 in a condition before formation of the crimp portion 138s, the oxygen sensor element 10, the metal packing 108, the metal holder 104, the ceramic holder 151, and the powder filler layer 156. A portion of the metallic shell 138 in which the metal packing 108 and the powder filler layer 156 are disposed has an inside diameter of 10 mm, and the oxygen sensor element 10 has a length in the width direction of 4.25 mm and a length in the thickness direction of 1.46 mm. Also, the powder filler layer 156 has a weight of 2.4 g. The prepared metal packing 108 has an outside diameter of 9.9 mm and has an insertion hole which has a substantially rectangular cross section and measures 4.55 mm×1.7 mm×1.5 mm (height).

Next, the oxygen sensor element 10, the metal holder 104, the ceramic holder 151, the power filler layer 156, and the metal packing 108 were inserted into the metallic shell 138, and then a rear end portion of the metallic shell 138 was crimped, thereby forming the crimp portion 138s. In this case, a crimping load α kg was applied to the crimp portion 138s of the metallic shell 138 so as to establish a filling density of 2.5 g/cm³ for talc. After this assembling work, the clearance S between the oxygen sensor element 10 and the metal packing 108 is 0.12 mm or 0.15 mm.

Subsequently, air was blown at a pressure of 1.5 MPa against the clearance of the oxygen sensor element 10 and the metallic shell 138 of the sample assembly from the forward side of the oxygen sensor element 10. The rate of leakage (ml/min) toward the rear side of the oxygen sensor element 10 was measured.

As a result, Example 1 showed a leakage rate of 1.1 ml/min.

Similar to the sample assembly of Example 1, sample assemblies of Comparative Examples 1, 2, and 3 were formed. The sample assembly of Comparative Example 1 employed a metal packing having an outside diameter of 9.9 mm as measured at its rear end, a through-hole measuring 4.55 mm×1.7 mm×1.5 mm (height), and a section which tapers off in the forward direction.

The sample assembly of Comparative Example 2 employed a metal packing having an outside diameter of 9.1 mm and a through-hole having a substantially rectangular cross section and measuring 4.55 mm×1.7 mm×1.5 mm (height).

The sample assembly of Comparative Example 3 employed a metal packing having an outside diameter of 9.9 mm and a through-hole having a substantially rectangular cross section and measuring 5.8 mm×3 mm×1.5 mm (height).

Similar to Example 1, the oxygen sensor element 10, the metal holder 104, the ceramic holder 151, the power filler layer 156, and each of the metal packings of Comparative Examples 1 to 3 were inserted into the metallic shell 138, and then a rear end portion of the metallic shell 138 was crimped, thereby forming the crimp portion 138s. In the crimping process, the same crimping load as that of Example 1; i.e., α kg, was applied.

Subsequently, similar to Example 1, air was blown against the sample assemblies of Comparative Examples 1 to 3, and the rate of leakage (ml/min) toward the rear side of the oxygen sensor element 10 was measured.

As a result, Comparative Example 1 showed a leakage rate of 2.0 ml/min; Comparative Example 2 showed a leakage rate of 1.5 ml/min; and Comparative Example 3 showed a leakage rate of 1.8 ml/min. The leakage rates of Comparative Examples 1 to 3 are higher than that of Example 1.

A conceivable reason for increase in leakage in Comparative Example 1 is as follows: since the forward oriented surface of the metal packing is inclined from the rearward oriented surface of the powder filler layer, the powder filler layer failed to sufficiently fill a relevant space.

A conceivable reason for increase in leakage in Comparative Example 2 is as follows: since the outside diameter of the flat surface of the metal packing is less than that of the rearward oriented surface of the seal member, the powder filler layer failed to sufficiently fill a relevant space.

A conceivable reason for increase in leakage in Comparative Example 3 is as follows: since the clearance between an inner edge of the flat surface of the metal packing and the surface of the gas sensor element is in excess of one-half the thickness of the gas sensor element, the powder filler layer failed to sufficiently fill a relevant space.

The present invention is not limited to the above embodiment, but may encompass various modifications and equivalents thereof without departing from the gist of the invention.

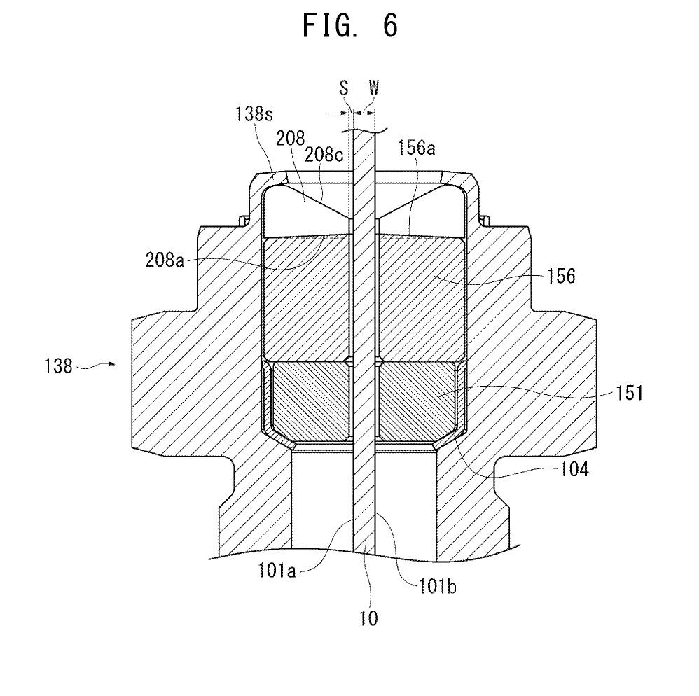

For example, no particular limitation is imposed on the shape of the metal packing 108, and the rearward oriented surface may not be flat and may be chamfered so long as the forward oriented surface in contact with the seal member is flat. For example, as shown in FIG. 6, while a metal packing 208 has a flat surface 208a as a forward oriented surface, a rearward oriented surface 208c may be curved such that the thickness of the metal packing 208 reduces along the radially inward direction.

In the above embodiment, the flat surface 108a of the metal packing 108 extend substantially perpendicularly to the axial direction. However, as shown in FIG. 6, as compared with the broken line perpendicular to the axial direction, the flat surface 208a may be shifted forward while extending radially outward. In this manner, by means of the flat surface 208a of the metal packing 208 being shifted forward while extending radially outward, the flat surface 208a may press the powder filler layer 156 with greater force.

The sensor element can be a λ sensor element, an NOₓ sensor element, and an ammonia sensor element, in addition to the above-described oxygen sensor element (a full-range air/fuel ratio sensor element).

### DESCRIPTION OF REFERENCE NUMERALS

10: oxygen sensor element
108: metal packing
108a: forward oriented surface of metal packing
138: metallic shell
138a: hexagonal portion
138b: threaded portion
152: ledge
154: through-hole of metallic shell
156: powder filler layer
200: gas sensor
O: axial direction

1. A gas sensor comprising:
a plate-like gas sensor element extending in an axial direction and having at least one cell which includes a solid electrolyte body and a pair of electrodes provided on a surface of the solid electrolyte body;
a tubular metallic shell having a through-hole through which the gas sensor element extends, and adapted to hold the gas sensor element in such a manner that a detection portion formed at a forward end portion of the gas sensor element projects therefrom; and
a seal member disposed between an inner surface of the metallic shell and an outer surface of the gas sensor element and adapted to maintain gastightness in a gap between the gas sensor element and the metallic shell;
the gas sensor further comprising a metal packing having a through-hole which has a substantially rectangular cross section and through which the gas sensor element extends, and pressing forward the seal member with a flat surface thereof in direct contact with a rearward oriented surface of the seal member,
the flat surface of the metal packing having an outside diameter equal to or greater than that of the rearward oriented surface of the seal member, and
a clearance between an inner edge of the flat surface of the metal packing and a surface of the gas sensor element being one-half or less a thickness of the gas sensor element.

2. A gas sensor as claimed in claim 1, wherein thermal expansion coefficient of the metal packing is higher than that of the metallic shell.

3. A gas sensor as claimed in claim 1, wherein side surfaces of the gas sensor element disposed in the through-hole of the metal packing are formed from an insulation material.

4. A gas sensor as claimed in claim 1, wherein a gap between the metallic shell and the metal packing is smaller than that between the gas sensor element and the metal packing.

5. A gas sensor as claimed in claim 1, wherein
the metallic shell has a crimp portion located rearward of the metal packing, projecting radially inward while having a gap between the same and the gas sensor element, and pressing forward the metal packing;
the metal packing has a maximum thickness T at a position where the metal packing and the crimp portion overlap each other in the axial direction; and
the maximum thickness T of the metal packing is greater than a maximum thickness t of the crimp portion.

6. A gas sensor as claimed in claim 1, wherein as viewed on a section which is taken radially and contains the flat surface of the metal packing, the gas sensor element has a substantially rectangular shape such that a length in a width direction is longer than a length in a thickness direction, and the clearance in the thickness direction between the gas sensor element and the metal packing is smaller than the clearance in the width direction between the gas sensor element and the metal packing.

7. A gas sensor as claimed in claim 1, wherein
the metallic shell has a hexagonal portion, a threaded portion disposed forward of the hexagonal portion and having a diameter smaller than that of the hexagonal portion, and a ledge projecting radially inward into the through-hole thereof and being in direct or indirect contact with a forward end of the seal member, and
a rearward oriented surface of the ledge is located rearward of the threaded portion.
